(19) United States
(12) Patent Application Publication
(10) Pub. No.: US 2013/0339233 A1
(43) Pub. Date: Dec. 19, 2013

(54) ELECTRONIC WALLET BASED PAYMENT

(71) Applicant: KT Corporation, Seongnam-si (KR)

(72) Inventors: Sang-Yup LEE, Seoul (KR); Soochul PARK, Seongnam-si (KR); Ki-Min OH, Seoul (KR)

(21) Appl. No.: 13/919,387

(22) Filed: Jun. 17, 2013

(30) Foreign Application Priority Data
Jun. 15, 2012 (KR) 10-2012-0064407

(51) Int. Cl. G06Q 20/36

(52) U.S. Cl. CPC G06Q 20/36
USPC 705/41

(57) ABSTRACT

In one example embodiment, a method performed by a server includes issuing an electronic wallet to be hosted on an end device, transmitting, to a bank, a request to generate a virtual account corresponding to the issued electronic wallet, receiving, from the end device, a transaction request including a payment amount and a store identifier and transmitting, to the bank, a request to transfer the payment amount from the virtual account to a store account corresponding to the store identifier.

### TECHNICAL FIELD

The embodiments described herein pertain generally to payment services based on an electronic wallet hosted on an end device.

### BACKGROUND

When shopping at a retail store, a customer typically hands a cashier a payment instrument such as a credit card, a debit card, cash, check, etc. to complete a transaction. Now, as mobile communication systems become ubiquitous, “cashless” transactions are becoming increasingly more commonplace than the exchange of the aforementioned payment instruments.

### SUMMARY

In one example embodiment, there is provided a method performed by a server. The method includes issuing an electronic wallet to be hosted on an end device; transmitting, to a bank, a request to generate a virtual account corresponding to the issued electronic wallet; receiving, from the end device, a transaction request including a payment amount and a store identifier; and transmitting, to the bank, a request to transfer the payment amount from the virtual account to a store account corresponding to the store identifier.

In another example embodiment, there is provided a method performed by an end device. The method includes transmitting, to a server, a request to issue an electronic wallet and to generate a virtual account; receiving, from the server, a notification that the electronic wallet has been issued and a notification that the virtual account has been generated; receiving input data including a payment amount and a store identifier; and transmitting, to the server, transaction information including the payment amount and the store identifier.

In yet another example embodiment, a server includes a memory configured to store a transaction password associated with an identifier of an end device; a processor configured to issue an electronic wallet to be hosted on the end device; a transmitter configured to transmit, to a bank, a request to generate a virtual account corresponding to the issued electronic wallet; and a receiver configured to receive, from the end device, a transaction request including a payment amount, a store identifier and a test transaction password. The processor may be further configured to compare the test transaction password included in the transaction request with the transaction password stored in the memory; and the transmitter may be further configured to transmit, to the bank, a request to transfer the payment amount from the virtual account to a store account corresponding to the store identifier.

In yet another example embodiment, an end device includes a transmitter configured to transmit, to a server, a request to issue an electronic wallet and generate a virtual account; a receiver configured to receive, from the server, a notification that the electronic wallet has been issued and a notification that the virtual account has been generated; and an input unit configured to receive an input of a payment amount and a store identifier. The transmitter may be further configured to transmit, to the server, transaction information including the payment amount and the store identifier.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of electronic wallet based payment may be implemented;

FIG. 2 shows an example processing flow of operations for implementing at least portions of issuing an electronic wallet and generating a corresponding virtual account;

FIG. 3 shows an illustrative example of an end device in which one or more embodiments of electronic wallet based payment may be implemented;

FIGS. 4A and 4B together show an example processing flow of operations for implementing at least portions of making a payment utilizing an electronic wallet;

FIG. 5 shows yet another illustrative example of an end device in which one or more embodiments of electronic wallet based payment may be implemented;

FIG. 6 shows an example processing flow of operations for implementing at least portions of increasing a current balance corresponding to an electronic wallet;

FIG. 7 shows yet another example processing flow of operations for implementing at least portions of increasing a current balance corresponding to an electronic wallet;

FIG. 8 shows an example configuration of a server by which at least portions of electronic wallet based payment may be implemented;

FIG. 9 shows still another example configuration of a server by which at least portions of electronic wallet based payment may be implemented;

FIG. 10 shows an example configuration of a service providing manager by which at least portions of electronic wallet based payment may be implemented;

FIG. 11 shows an example configuration of an end device by which at least portions of electronic wallet based payment may be implemented;

FIG. 12 shows still another example configuration of a server by which at least portions of electronic wallet based payment may be implemented;

FIG. 13 shows an example configuration of a service request manager by which at least portions of electronic wallet based payment may be implemented; and

FIG. 14 shows an illustrative computing embodiment, in which any of the processes and sub-processes of electronic wallet based payment may be implemented as computer-readable instructions stored on a computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

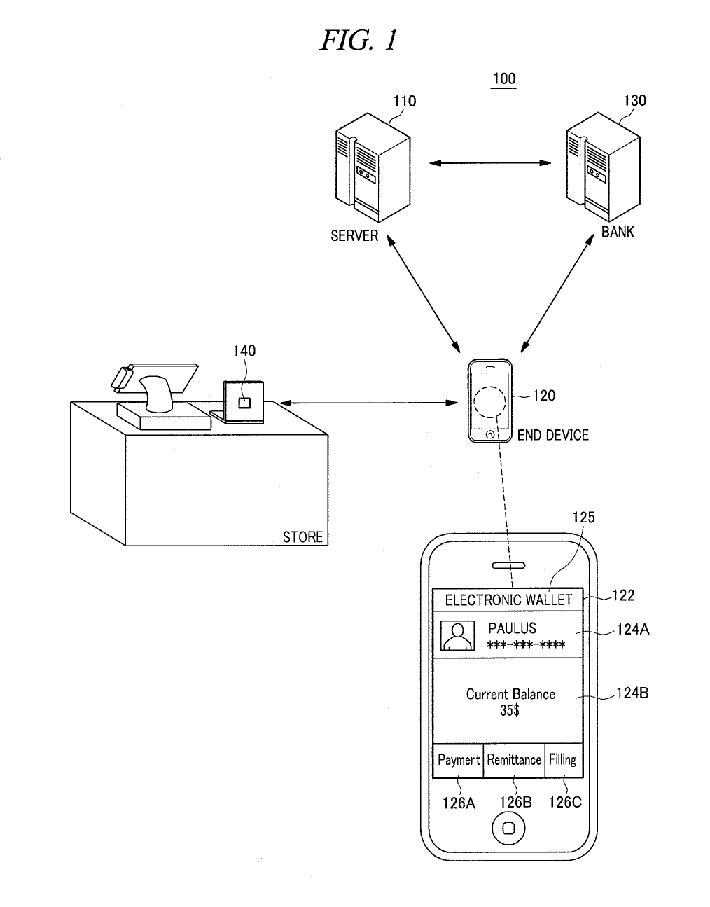

FIG. 1 shows an example system configuration 100 in which one or more embodiments of electronic wallet based payment may be implemented. As depicted in FIG. 1, system configuration 100 includes, at least, a server 110, an end device 120, one or more bank servers 130 (operated by a bank or other financial institution; referred hereafter as “bank server 130” though not limiting in quantity) and an electronic tag 140, which may be attached to a surface of an object, such as a checkout counter, a point of sale (POS) terminal, etc., located at a place of commerce. Alternatively, electronic tag 140 may be inserted in the example objects as an electronic chip. At least one of server 110, end device 120, bank server 130 and electronic tag 140 may be connected to each other via a wireless network or a wired network.

As referenced herein, “an electronic wallet 122” may refer to an application that may be hosted and executed on end device 120 to facilitate cashless transactions between a user of end device 120, to whom a corresponding virtual account has been generated, and a participating place of commerce. For example, the user may download the application from a virtual application market, such as the Apple™ App Store, the Google™ Google Play, etc. End device 120 may transmit to server 110 a request to issue electronic wallet 122 via the downloaded application, and server 110 may issue electronic wallet 122 to end device 120. Further, when end device 120 receives from server 110 data regarding electronic wallet 122, end device 120 may activate the downloaded application as electronic wallet 122 by using the received data regarding electronic wallet 122. Further, end device 120 may make a payment from the virtual account to a bank account of a store by manipulating electronic wallet 122. As depicted in FIG. 1, end device 120 may be configured to display electronic wallet 122 on a display panel 125 installed on end device 120. By way of example, electronic wallet 122 may show a user interface including a first field 124A, a second field 124B, a “Payment” icon 126A, a “Remittance” icon 126B and a “Filling” icon 126C. As referenced herein, first field 124A may include identification information for the user of end device 120, such as an image, a user name, an account identifier of a virtual account corresponding to electronic wallet 122, etc. Second field 124B may include a current balance corresponding to electronic wallet 122. As referenced herein, the current balance corresponding to electronic wallet 122 may be independently managed by server 110. Each of icons 126A, 126B and 126C may include a predetermined command, respectively. For example, icon 126A may be clicked, selected, or otherwise activated to make a payment; and icon 126B may be clicked, selected, or otherwise activated to make a remittance; and icon 126C may be clicked, selected, or otherwise activated to replenish the virtual account corresponding to electronic wallet 122 issued to the user of end device 120.

As referenced herein, an “electronic tag,” also known as a “smart tag” or “NEC tag” or “RFID tag,” may be an electronic identification device that includes a chip and antenna.

Server 110 may be configured to issue electronic wallet 122 to be hosted on end device 120 in response to the request to issue electronic wallet 122 received from end device 120, and to match an account identifier of the virtual account to issued electronic wallet 122. Server 110 may be hosted by a service provider. As referenced herein, the virtual account may be generated by bank server 130 in response to a request to generate the virtual account transmitted from server 110 to bank server 130, and the account identifier of the virtual account may be transmitted from bank server 130 to server 110. Further, as referenced herein, the request to generate the virtual account may be transmitted from server 110 to bank server 130 when issuing electronic wallet 122. Alternatively, the request to generate the virtual account may be transmitted to bank server 130 when server 110 receives the request to issue electronic wallet 122 from end device 120. Then, server 110 may transmit, to end device 120, a notification that electronic wallet 122 has been issued and the virtual account has been generated, with the account identifier of the generated virtual account.

Server 110 may be further configured to receive a transaction request including a payment amount and a store identifier from end device 120; and then, transmit, to bank server 130, a request to transfer the payment amount from the virtual account to a store account for a place of commerce corresponding to the store identifier in order to complete a transaction. As referenced herein, non-limiting examples of the store identifier may include at least one of a store name, a store address, a telephone number of the store, a point of sale (POS) terminal number or a business license number. As further referenced herein, the request to transfer the payment amount may include the account identifier of the virtual account and an account identifier of the store account. The account identifier of the store account may be retrieved from a memory of server 110 by using the received store identifier. Then, server 110 may receive a notification indicating completion of payment from bank server 130, and transmit the notification indicating completion of payment to end device 120. As referenced herein, the notification indicating completion of payment may be transmitted from server 110 to end device 120 with an electronic receipt. As further referenced herein, the electronic receipt may include the current balance corresponding to electronic wallet 122, the payment amount, store information, such as a name of a store, an address of the store, a telephone number of the store, the account identifier of the store account corresponding to the store, etc.

End device 120 may refer to at least one of a mobile phone, a portable device, a notebook, a personal computer or a personal communication terminal. Non-limiting examples of such devices may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

End device 120 may be configured to transmit the request to issue electronic wallet 122 to server 110. As referenced herein, the transmitted request to issue electronic wallet 122 may also include a request to generate the virtual account. Then, end device 120 may receive, from server 110, a notification that electronic wallet 122 has been issued and that the virtual account has been generated, with the account identifier of the virtual account. Alternatively, end device 120 may receive the notification that the virtual account has been generated from bank server 130.

In some embodiments, end device 120 may include a reader that is enabled to read information from an electronic tag. By way of example, but not limitation, the reader integrated in or coupled to end device 120 may include one or more of a radio frequency identification reader, a near field communication reader, a barcode reader, a quick response code reader, etc.

End device 120 may be further configured to read electronic tag 140 located within a predetermined communication range of end device 120 by using the aforementioned reader to acquire a store identifier stored in electronic tag 140. End device 120 may transmit the acquired store identifier to server 110 to request aforementioned store information corresponding to the acquired store identifier. In some embodiments, the store information may be pre-stored in electronic tag 140. That is, end device 120 may acquire the store information by reading electronic tag 140 by using the reader coupled to end device 120.

End device 120 may be further configured to receive input data including the payment amount by the user of end device 120 through a user input. Alternatively, end device 120 may receive the payment amount, as a cashier beams the payment amount to end device 120. End device 120 may be further configured to transmit the transaction request including the payment amount and the acquired store identifier to server 110. As referenced herein, the transmitted store identifier may be used by server 110 to retrieve the account identifier of the store account for payment of the payment amount. In some embodiments, end device may acquire the account identifier of the store account that is pre-stored in electronic tag 140 by reading electronic tag 140, and then, transmit the acquired account identifier of the store account to server 110. End device 120 may be configured to receive, from server 110, the notification indicating completion of payment with the electronic receipt. Alternatively, end device 120 may receive the notification indicating completion of payment with the electronic receipt from bank server 130.

End device 120 may be further configured to display at least one of the notification that electronic wallet 122 has been issued or the notification that the virtual account has been generated on display panel 125 installed on or coupled to end device 120, to inform the user that electronic wallet 122 has been successfully issued and the virtual account has been successfully generated. Further, end device 120 may display at least one of the notification indicating completion of payment, the store information or the electronic receipt on display panel 125 installed on or coupled to end device 120, to inform the user that a payment has been successfully completed.

Bank server 130 may be configured to receive the request to generate the virtual account corresponding to electronic wallet 122, and further, to generate the requested virtual account. Bank server 130 may be configured to transmit the notification that the virtual account has been generated to server 110 or end device 120.

Bank server 130 may be further configured to receive, from server 110, the request to transfer the payment amount from the virtual account to the store account with the account identifier of the virtual account and the account identifier of the store account. Bank server 130 may be further configured to transfer the payment amount from the virtual account to the store account by using the account identifier of the virtual account and the account identifier of the store account. Bank server 130 may further transmit the notification indicating completion of payment to server 110. In some embodiments, bank server 130 may be configured to transmit the notification indicating completion of payment to end device 120.

Electronic tag 140, by way of example but not limitation, may include at least one of a barcode, a quick response code, a smart tag, a radio frequency identification (RFID) tag, a near field communication (NFC) tag, etc. Further, as referenced herein, an electronic tag 140 may be an electronic identification device that includes a chip and antenna.

Thus, FIG. 1 shows example system configuration 100 in which one or more embodiments of electronic wallet based payment may be implemented.

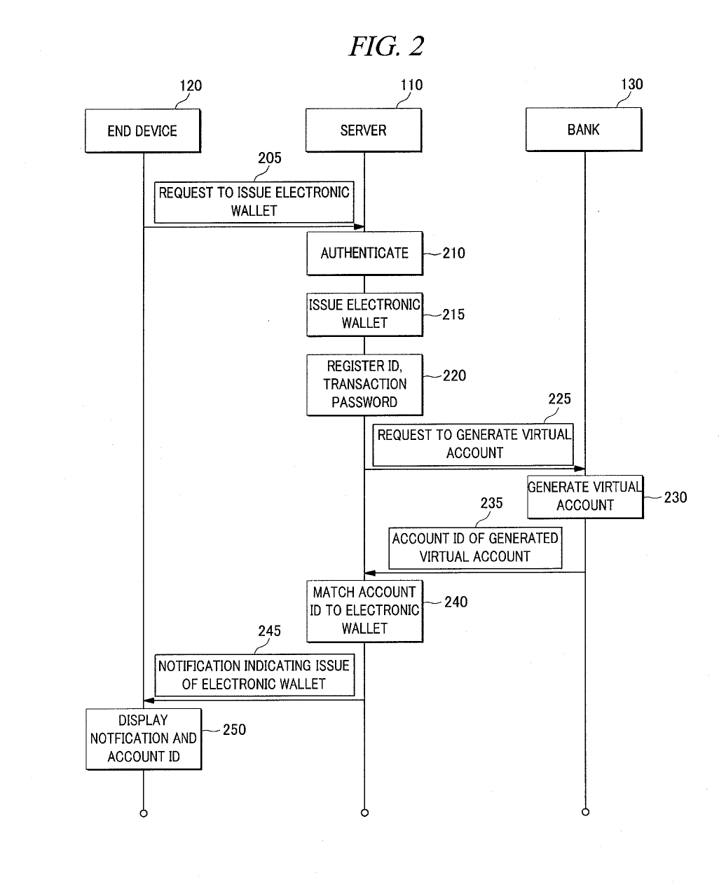

FIG. 2 shows an example processing flow of operations for implementing at least portions of issuing electronic wallet 122 and generating a corresponding virtual account. The process in FIG. 2 may be implemented in system configuration 100 including server 110, end device 120 and bank server 130, as described with reference to FIG. 1. An example process may include one or more operations, actions, or functions as illustrated by one or more blocks 205, 210, 215, 220, 225, 230, 235, 240, 245 and/or 250. Although illustrated as discrete blocks, various blocks may be divided into additional blocks, combined into fewer blocks, or eliminated, depending on the desired implementation. Processing may begin at block 205.

Block 205 (Transmit Request to Issue Electronic wallet) may refer to end device 120 transmitting, to server 110 of a service provider, a request to issue electronic wallet 122 to be hosted on end device 120. As referenced herein, the request to issue electronic wallet 122 may be transmitted, from end device 120 to server 110, as a text/SMS, email, or even voice message via an application downloaded from a virtual application market, such as the Apple™ App Store, the Google™ Google Play, etc. As set forth above, the request to issue electronic wallet 122 may also include a request to generate a virtual account corresponding to electronic wallet 122.

At least one password may be composed of at least one of a letter or a digit. In some embodiments, the at least one password may be a certain pattern having a direction. As referenced herein, the request to issue electronic wallet 122 may include at least one of an identifier, a transaction password or a virtual account password. As further referenced herein, the identifier may include a user identifier and/or an end device identifier. Non-limiting examples of the user identifier may include at least one of a user name, an email address, an Internet Personal Identification Number (I-PIN), a social security number, a passport number, a driver's license number, etc. Further, non-limiting examples of the end device identifier may include at least one of a telephone number of end device 120, a serial number of the end device, a Universal Subscriber Identity Module (USIM), an International Mobile Subscriber Identity (IMSI), a Globally Unique Temporary Identifier (GUTI), a Media Access Control (MAC) address, etc.

In some embodiments, end device 120 may be further configured to transmit, to server 110, a request to join an electronic wallet based payment service to be provided on electronic wallet 122. The request to join may include the request to issue electronic wallet 122. As referenced herein, the request to join may include a login identifier and/or a login password for electronic wallet 122. In this case, the user identifier or the end device identifier included in the request to issue may be substituted for the login identifier included in the request to join. That is, server 110 may register the user identifier or the end device identifier included in the request to issue as the login identifier for electronic wallet 122.

Thus, at block 205, end device 120 may transmit the request to issue electronic wallet 122 when end device 120 receives a user input corresponding to the request to issue electronic wallet 122 from a user of end device 120. Processing may proceed from block 205 to block 210.

Block 210 (Authenticate End Device and/or User Identifier) may refer to server 110 authenticating end device 120 before issuing electronic wallet 122. By way of example, server 110 may generate authentication information, such as an authentication code, an authentication number, an authentication image showing certain digit and/or letter, etc., and transmit the generated authentication information to end device 120. The generated authentication information may be transmitted to end device 120, by server 110, as a form of an instant message, push message, text/SMS, etc. Server 110 may receive, from end device 120, test authentication information in response to the transmitted authentication information and determine whether the generated authentication information is identical to the received test authentication information. In some embodiments, block 210 may refer to server 110 authenticating the user identifier included in the request before issuing electronic wallet 122. For example, server 110 may authenticate the user identifier by determining whether the at least one of Internet Personal Identification Number (I-PIN), social security number, passport number or driver's license number corresponds to the user of end device 120. As referenced herein, the determining may be executed by an outside organization which manages personal security information. Processing may proceed from block 210 to block 215.

Block 215 (Issue Electronic wallet) may refer to server 110 issuing electronic wallet 122 based on the transmitted request to issue electronic wallet 122. Further, server 110 may configured to register issued electronic wallet 122 in a memory. Processing may proceed from block 215 to block 220.

Block 220 (Register Identifier and/or Transaction Password) may refer to server 110 registering the received identifier and/or transaction password with respect to registered electronic wallet 122. As referenced herein, the identifier may include an end device or a user identifier. Processing may proceed from block 220 to block 225.

Block 225 (Transmit Request to Generate Virtual Account) may refer to server 110 transmitting a request to generate a virtual account corresponding to issued electronic wallet 122 to bank server 130. As referenced herein, the request to generate a virtual account may include at least one of the received user identifier, the received end device identifier or information regarding issued electronic wallet 122. Further, when bank server 130 receives the virtual account password, bank server 130 may register the received virtual account password with the generated virtual account. Processing may proceed from block 225 to block 230.

Block 230 (Generate Virtual Account) may refer to bank server 130 generating the virtual account corresponding to issued electronic wallet 122. In some embodiments, with respect to an issued single electronic wallet, bank server 130 may generate multiple virtual accounts, and each virtual account may be matched to a predefined usage, such as a utility fee, a health insurance premium, etc. In contrast, if a single user owns multiple end devices, a single virtual account may correspond to multiple electronic wallets. That is, the single virtual account may be shared with the multiple electronic wallets corresponding to the multiple end devices of the single user. Processing may proceed from block 230 to block 235.

Block 235 (Transmit Account Identifier of Generated Virtual Account) may refer to bank server 130 transmitting an account identifier of the generated virtual account, such as an account number, to server 110. Bank server 130 may further transmit, to server 110, a notification that the virtual account has been generated. Processing may proceed from block 235 to block 240.

Block 240 (Match Account Identifier to Electronic wallet) may refer to server 110 matching the received account identifier of the generated virtual account to issued electronic wallet 122. Thus, server 110 may manage both electronic wallet 122 and the account identifier of the virtual account together. As referenced herein, when server 110 receives a transaction request including a payment amount and a store identifier from end device 120, server 110 may retrieve the account identifier of the generated virtual account and an account identifier of a store account. Further, server 110 may insert the retrieved account identifier of the virtual account, the account identifier of the store account and the payment amount to a request to transfer the payment amount from the virtual account to the store account, and the request to transfer may be transmitted from server 110 to bank server 130. Processing may proceed from block 240 to block 245.

Block 245 (Transmit Notification indicating Issue of Electronic wallet) may refer to server 110 transmitting a notification that electronic wallet 122 has been issued to end device 120. Block 245 may refer to server 110 further transmitting a notification that the virtual account has been generated with the notification that electronic wallet 122 has been issued to end device 120. As referenced herein, the notification that the virtual account has been generated may include the account identifier of the virtual account. Further, server 110 may transmit to end device 120 data regarding issued electronic wallet 122 to activate the downloaded application as electronic wallet 122. Processing may proceed from block 245 to block 250.

Block 250 (Display Notification and Account Identifier) may refer to end device 120 displaying at least one of the notification that electronic wallet 122 has been issued or the notification that the virtual account has been generated with the account identifier of the virtual account on a display panel installed on or coupled to end device 120. Thus, the user of end device 120 may be informed that requested electronic wallet 122 has been issued and/or the virtual account has been generated safely. Further, end device 120 may receive from server 110 the data regarding issued electronic wallet 122, and activate the downloaded application as electronic wallet 122 by using the received data regarding electronic wallet 122.

Thus, FIG. 2 shows an example processing flow of operations for implementing at least portions of issuing electronic wallet 122 and generating virtual account.

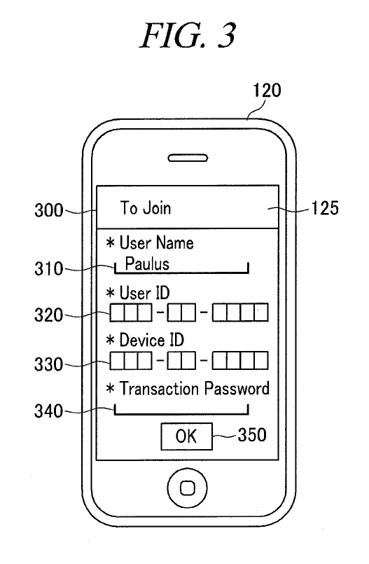

FIG. 3 shows an illustrative example of an end device in which one or more embodiments of electronic wallet based payment may be implemented. End device 120, which is described above with regard to FIG. 1, may be configured to display a user interface 300 for joining an electronic wallet based transaction service on a display panel 125 installed on end device 120. End device 120 may be configured to display user interface 300 when receiving a user input with respect to a request to issue electronic wallet 122.

By way of example, as depicted in FIG. 3, user interface 300 may include input fields for a user name 310, a user identifier 320, an end device identifier 330 and a transaction password 340, and an “OK” icon 350.

As referenced herein, non-limiting examples of the user identifier to be input into input field 320 may include at least one of an email address, an Internet Personal Identification Number (I-PIN), a social security number, a passport number, a driver's license number, etc. As further referenced herein, non-limiting examples of the end device identifier to be input to input field 330 may include at least one of a telephone number of end device 120, a serial number of end device 120, an International Mobile Subscriber Identity (IMSI), a Globally Unique Temporary Identifier (GUTI), a Media Access Control (MAC) address, etc. When a user inputs the user name, the user identifier, the end device identifier and the transaction password respectively on each input field and click or otherwise activate “OK” icon 350, end device 120 may transmit a request to issue electronic wallet 122 including the input information to server 110. As referenced herein, “OK” icon 250 may refer to a UI button that may be clicked or activated to indicate a user selection, and may otherwise be labeled as “enter,” “confirm,” etc.

In some embodiments, user interface 300 may further include at least one input field for a login identifier, a login password or a virtual account password. In some other embodiments, user interface 300 may further include an icon corresponding to a request for authentication information and an input field for authentication information. For example, when the user of end device 120 clicks or otherwise activates the icon to transmit a request for authentication information to server 110, end device 120 may transmit the request for authentication information to server 110 and receive the authentication information from server 110. When the user inputs the received authentication information correctly on the field for authentication information, server 110 may authenticate end device 120. In still some other embodiments, user interface 300 may further include at least one icon that may be clicked or otherwise activated to transmit a request to confirm that each input information is proper or available.

Thus, FIG. 3 shows an illustrative example of an end device in which one or more embodiments of electronic wallet based payment may be implemented.

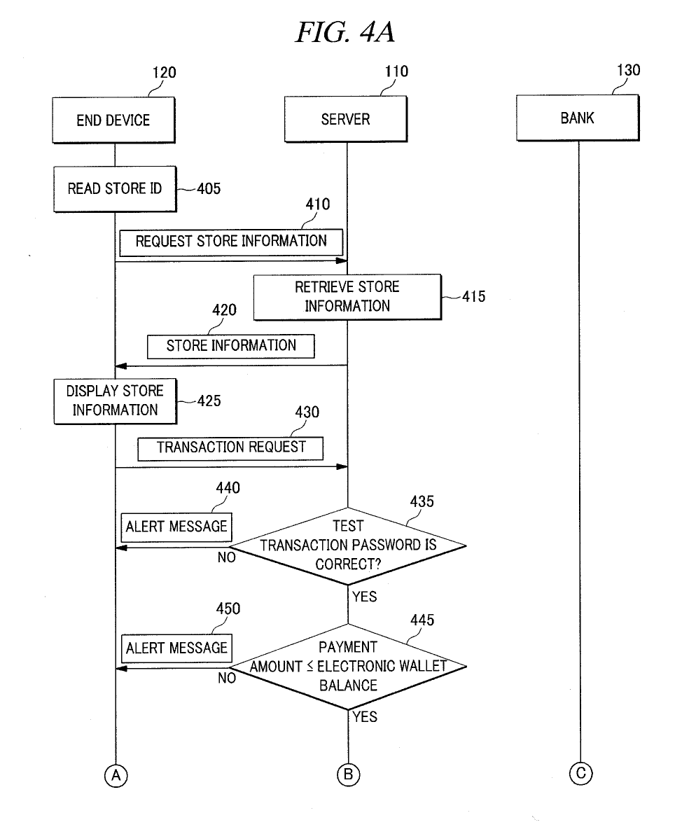

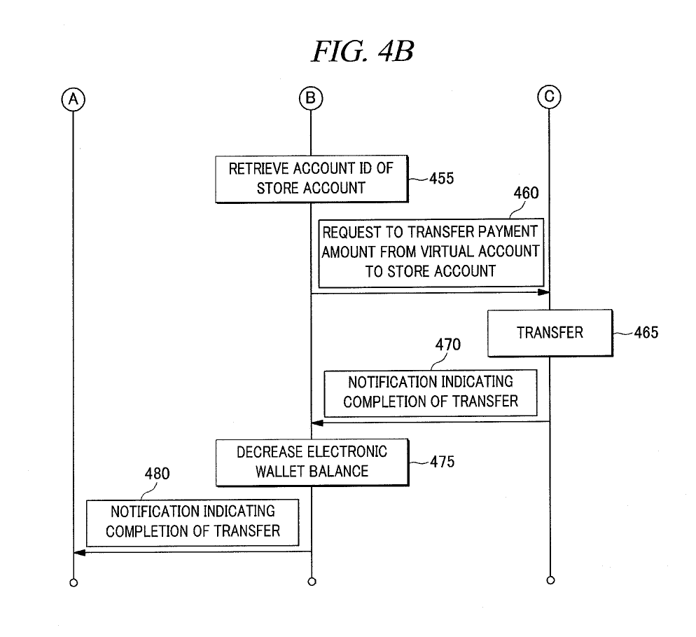

FIGS. 4A and 4B together show an example processing flow of operations for implementing at least portions of making a payment utilizing electronic wallet 122. The process in FIG. 4 may be implemented in system configuration 100 including server 110, end device 120 and bank server 130, as described with reference to FIG. 1. An example process may include one or more operations, actions, or functions as illustrated by one or more blocks 405, 410, 415, 420, 425, 430, 435, 440, 445, 450, 455, 460, 465, 470, 475 and/or 480. Although illustrated as discrete blocks, various blocks may be divided into additional blocks, combined into fewer blocks, or eliminated, depending on the desired implementation. Processing may begin at block 405.

Block 405 (Read Store identifier) may refer to end device 120 reading a store identifier, which may be received from an electronic tag 140 located within predetermined communication range of end device 120. Non-limiting examples of electronic tag 140 may include a barcode, a quick response code, a smart tag, a radio frequency identification (RFID) tag, a near field communication (NFC) tag, etc. For example, end device 120 may capture electronic tag 140, which may be attached to a surface of an object, such as the barcode or the quick response code, by using an image sensor integrated in or coupled to end device 120. Thus, end device 120 may acquire the store identifier pre-stored in electronic tag 140. As referenced herein, non-limiting examples of the object may include a checkout counter, a point of sale (POS) terminal, etc. In some embodiments, end device 120 and electronic tag 140 make physical contact or are in close proximity of each other, end device 120 may recognize electronic tag 140, which may be inserted in the objects as an electronic chip, such as a near field communication tag or a radio frequency identification tag. As a result, end device 120 may acquire the store identifier. In some other embodiments, end device 120 may acquire the store identifier by receiving a user input including the store identifier. Processing may proceed from block 405 to block 410.

Block 410 (Transmit Request Store Information) may refer to end device 120 transmitting a request for store information to server 110 by inserting the read store identifier into the request. Processing may proceed from block 410 to block 415.

Block 415 (Retrieve Store Information) may refer to server 110 retrieving the store information from a memory by using the store identifier. As referenced herein, the store information, such as a store name, a store address, a telephone number of the store or an account identifier of a store account corresponding to the store, may be pre-stored in the memory of server 110. That is, server 110 may receive the store information, and then, register the received store information with respect to the store identifier in the memory. Processing may proceed from block 415 to block 420.

Block 420 (Transmit Store Information) may refer to server 110 transmitting the retrieved store information to end device 120. Processing may proceed from block 420 to block 425.

Block 425 (Display Store Information) may refer to end device 120 displaying the received store information on a display panel installed on or coupled to end device 120. Before making a payment, the user of end device 120 may determine whether the displayed store information is correct or not, and then, if the displayed store is correct, the user may determine to complete the payment. Processing may proceed from block 425 to block 430.

Block 430 (Transmit Transaction Request) may refer to end device 120 transmitting, to server 110, a transaction request including an end device identifier, a payment amount to be paid and a test transaction password that is newly input through a user input. As referenced herein, the payment amount may be input by the user through a user input. Alternatively, the payment amount may be transmitted by beaming the payment amount from a casher to user device 120. In some embodiments, the payment amount may be received from an electronic tag attached to a surface of an object, such as, a merchant that is to be bought, a price tag, a menu. Processing may proceed from block 430 to block 435.

Block 435 (Determine whether Test Transaction Password is Correct) may refer to server 110 determining whether the received test transaction password is correct or not by comparing the received test transaction password to a stored transaction password with respect to the received end device identifier. Processing may proceed from block 435 to block 440 or block 445 based on a result of the determination. That is, if the test transaction password is not correct, processing may proceed from block 435 to block 440; while if the test transaction password is correct, processing may proceed from block 435 to block 445.

Block 440 (Transmit Alert Message) may refer to server 110 transmitting a notification that the test transaction password is not correct, to end device 120, as an alert. In this case, end device 120 may display the received notification, and provide the user a chance to input a new test transaction password.

Block 445 (Determine whether Payment Amount is Same or Less than Current Balance corresponding to Electronic wallet) may refer to server 110 determining whether a payment amount is same or less than a current balance corresponding to electronic wallet 122 with respect to the received end device identifier. As referenced herein, the current balance corresponding to electronic wallet 122 may be independently managed by server 110 and be retrieved from the memory of server 110. Alternatively, server 110 may receive from bank server 130 a current balance of a virtual account independently managed by bank server 130 as the current balance corresponding to the electronic wallet. If the payment amount exceeds the current balance corresponding to electronic wallet 122, processing may proceed from block 445 to block 450; if the payment amount is same or less than the current balance corresponding to electronic wallet 122, processing may proceed from block 445 to block 455.

Block 450 (Transmit Alert Message) may refer to server 110 transmitting a notification that the payment amount exceeds the current balance corresponding to electronic wallet 122, to end device 120, as an alert. In this case, end device 120 may display the received notification, and then, display a user interface field to input an additional amount of funds or purchase credits into electronic wallet 122.

Block 455 (Retrieve Account Identifier of Store Account) may refer to server 110 retrieving the account identifier of the store account by using the received store identifier from the memory of server 110. In some embodiments, server 110 may determine whether the virtual account and/or the store account is available or not. Processing may proceed from block 455 to block 460.

Block 460 (Transmit Request to Transfer Payment Amount from Virtual Account to Store Account) may refer to server 110 transmitting, to bank server 130, a request to transfer the payment amount from the virtual account to the store account. As referenced herein, the request to transfer may include an account identifier of the virtual account, the retrieved account identifier of the store account and the received payment amount. For example, end device 120 may retrieve an account identifier of the virtual account corresponding to electronic wallet 122 by using the received end device identifier. Processing may proceed from block 460 to block 465.

Block 465 (Transfer Payment Amount) may refer to bank server 130 transferring the payment amount from the virtual account to the store account. Processing may proceed from block 465 to block 470.

Block 470 (Transmit Notification indicating Completion of Transfer) may refer to bank server 130 transmitting a notification indicating completion of transfer of the payment amount to server 110. Processing may proceed from block 470 to block 475.

Block 475 (Decrease Current Balance corresponding to Electronic wallet) may refer to server 110 decreasing the current balance corresponding to electronic wallet 122 by the payment amount. In some embodiments, server 110 may receive the current balance of the virtual account from bank server 130, and then adjust the current balance corresponding to electronic wallet 122 to equal the received current balance of the virtual account instead of decreasing the current balance corresponding to electronic wallet 122 by the payment amount. That is, the current balance corresponding to electronic wallet 122 needs to be the same as the current balance of the virtual account. Therefore, the current balance corresponding to electronic wallet 122 may be synchronized with the current balance of the virtual account. Processing may proceed from block 475 to block 480.

Block 480 (Transmit Notification indicating Completion of Transfer) may refer to server 110 transmitting the received notification indicating the completion of the transfer with the current balance corresponding to electronic wallet 122 independently managed by server 110. Further, end device 120 may display the received notification indicating the completion of the transfer with the current balance corresponding to electronic wallet 122 on a display panel. Thus, the user of end device 120 may be informed that the requested transaction has been completed and the requested payment amount has been transferred from the virtual account to the store account safely.

Thus, FIG. 4 shows an example processing flow of operations for implementing at least portions of paying a payment amount.

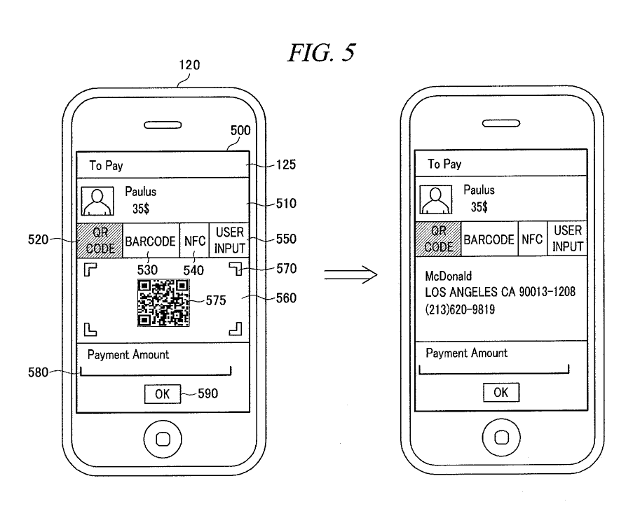

FIG. 5 shows yet another illustrative example of an end device in which one or more embodiments of electronic wallet based payment may be implemented. End device 120, which is described above with regard to FIG. 1, may be configured to display a user interface 500 for making a payment on a display panel 125 installed on end device 120. End device 120 may be configured to display user interface 500 when receiving a user input with respect to a request to make a payment.

By way of example, as depicted in FIG. 5, user interface 500 may include a first field 510, icons for a quick response code 520, a barcode 530, a near field communication 540 and a user input 550, a second field 560, an input field for a payment amount 580 and an “OK” icon 590.

First field 510 may include an image, a user name and a current balance corresponding to electronic wallet 122. First field 510 may further include at least one of a login identifier, a telephone number of end device 120 or an account identifier of a virtual account.

Based on which of icons 520 to 550 is clicked, selected, or otherwise activated, an entity to be shown on second field 580 may be determined. By way of examples, when an icon for the quick response code 520 is clicked, selected, or otherwise activated, indicators 570 that set a boundary to identify a quick response code 575 may be shown on second field 560. As depicted in FIG. 5, a camera integrated in or coupled to end device 120 may capture an image of quick response code 575 located near end device 120, and, then, the captured image may be shown in second field 560 to facilitate a capturing motion of a user of end device 120. Similarly, when an icon for the barcode 530 is clicked, selected, or otherwise activated, second field 560 may show indicators 570 that set a boundary to identify a barcode. In this case, the camera integrated in or coupled to end device 120 may capture an image of the barcode located near end device 120, and, then, the captured image may be shown in second field 560 to facilitate a capturing motion of the user of end device 120. When an icon for the near field communication 540 is clicked, selected, or otherwise activated, second field 560 may show a notice indicating that end device 120 may be close to a near field communication tag. Further, when an icon for the user input 550 is clicked, selected, or otherwise activated, second field 560 may show an field for the user to input a store identifier, such as, a store name, a store address, a telephone number of a store, a business license number, etc. Thus, end device 120 may acquire a store identifier and transmit the acquired store identifier to server 110. Then, end device 120 may receive store information corresponding to the store identifier from server 110, and display the received store information on second field 560.

As depicted in a left drawing of FIG. 5, the user may click, select, or otherwise activate an icon for the quick response code 520 and locate a quick response code 575 inside of indicators 570. Then, an entity shown on second field 560 may be changed into store information including “McDonald” as a store name, “Los Angeles, Calif. 90013-1208” as a store address and “(213) 620-9819” as a telephone number of the store corresponding to a store identifier as depicted in a right drawing of FIG. 5.

Input field for the payment amount 580 may be input a payment amount corresponding to merchandise price or service price to be paid. When a user inputs the payment amount on input field 580 and clicks, selects, or otherwise activates “OK” icon 590, end device 120 may transmit a transaction request to transfer the payment amount from a virtual account to a store account.

Thus, FIG. 5 shows yet another illustrative example of an end device in which one or more embodiments of electronic wallet based payment may be implemented.

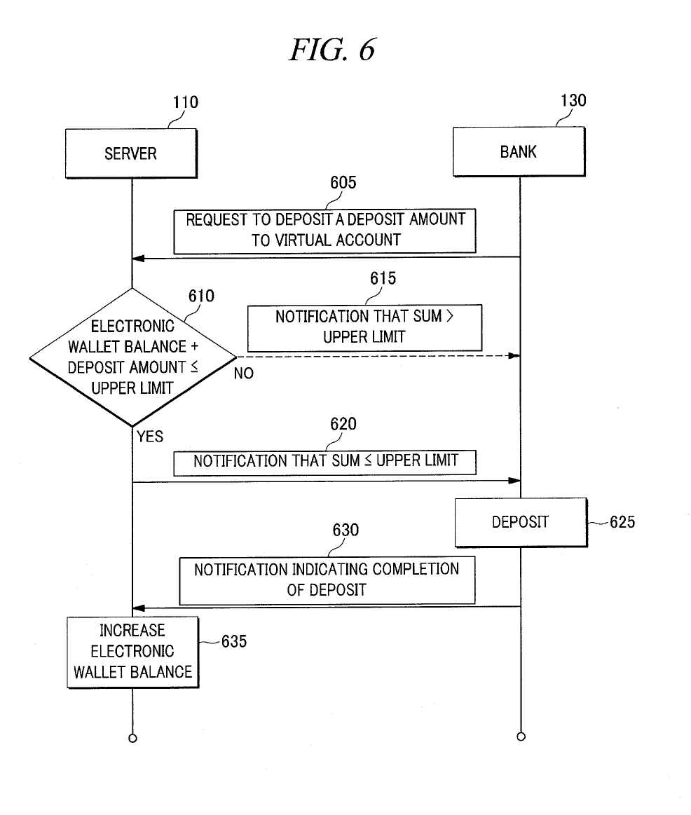

FIG. 6 shows an example processing flow of operations for implementing at least portions of increasing a current balance corresponding to electronic wallet 122. The process in FIG. 6 may be implemented in system configuration 100 including server 110 and bank server 130, as described with reference to FIG. 1. An example process may include one or more operations, actions, or functions as illustrated by one or more blocks 605, 610, 615, 620, 625, 630 and/or 635. Although illustrated as discrete blocks, various blocks may be divided into additional blocks, combined into fewer blocks, or eliminated, depending on the desired implementation. Processing may begin at block 605.

Block 605 (Transmit Request to Deposit a Deposit Amount to Virtual Account) may refer to bank server 130 transmitting a request to deposit a deposit amount to a virtual account corresponding to electronic wallet 122 hosted on end device 120. As referenced herein, the request to deposit may include the payment amount and an account identifier of the virtual account. Thus, when bank server 130 receives the deposit amount with the account identifier of the virtual account from an external source, bank server 130 may transmit, to server 110, the request to deposit to ask server 110 whether bank server 130 should deposit the deposit amount to the virtual account.

In some embodiments, the deposit amount may be matched to a predefined usage corresponding to the external source, such as a remittance, a payment, etc. By way of example, when the deposit amount is input into the virtual account from someone's virtual account, the deposit amount may be utilized for only making a payment. By way of other example, when the deposit amount is input into the virtual account from someone's credit card account, the deposit amount may be utilized for only remitting into someone's account. Processing may proceed from block 605 to block 610.

Block 610 (Determine whether Sum of Current Balance corresponding to Electronic wallet and Deposit Amount Exceeds Upper Limit allotted to Electronic wallet) may refer to server 110 determining whether a sum of a current balance corresponding to electronic wallet 122 independently managed by server 110 and the deposit amount exceeds an upper limit allotted to electronic wallet 122. As referenced herein, the upper limit allotted to electronic wallet 122 may be set by a user of end device 110 in advance. Further, the user may decide the upper limit through a user interface for setting the upper limit displayed on end device 120. If the sum exceeds the upper limit, processing may proceed from block 610 to block 615, while if the sum does not exceed the upper limit, processing may proceed from block 610 to block 620.

Block 615 (Transmit Notification that Sum Exceeds Upper Limit) may refer to server 110 transmitting a notification that the sum exceeds the upper limit to bank server 130 as a message indicating failure of the deposit. Then, bank server 130 may not deposit the deposit amount to the virtual account and therefore return the deposit amount to the external source with the notification that the sum exceeds the upper limit. Processing may proceed from block 615 to block 620.

Block 620 (Transmit Notification that Sum does not Exceed Upper Limit) may refer to server 110 transmitting a notification, to bank server 130, that the sum does not exceed the upper limit. In some embodiments, before transmitting the notification to bank server 130, server 110 may transmit, to end device 120, an acknowledgement that bank server 130 has received a deposit amount from an external source. Then, if server 110 receives a confirmation with respect to the acknowledge from end device 120, server 110 may transmit the notification to bank server 130. Processing may proceed from block 620 to block 625.

Block 625 (Deposit The Deposit Amount) may refer to bank server 130 depositing the deposit amount to the virtual account. Processing may proceed from block 625 to block 630.

Block 630 (Transmit Notification indicating Completion of Deposit) may refer to bank server 130 transmitting a notification indicating completion of the deposit to server 110. Bank server 130 may further transmit the notification indicating the completion to the outside. Processing may proceed from block 630 to block 635.

Block 635 (Increase Current Balance corresponding to Electronic wallet) may refer to server 110 increasing the current balance corresponding to electronic wallet 122 by the deposit amount. As a result, the current balance corresponding to electronic wallet 122 may equal a current balance of the virtual account independently managed by bank server 130. In some embodiments, server 110 may receive the current balance of the virtual account, and then adjust the current balance corresponding to electronic wallet 122 to equal the current balance of the virtual account. That is, the current balance corresponding to electronic wallet 122 needs to be the same as the current balance of the virtual account. Therefore, the current balance corresponding to electronic wallet 122 may be synchronized with the current balance of the virtual account.

Thus, FIG. 6 shows an example processing flow of operations for implementing at least portions of increasing a current balance corresponding to electronic wallet 122.

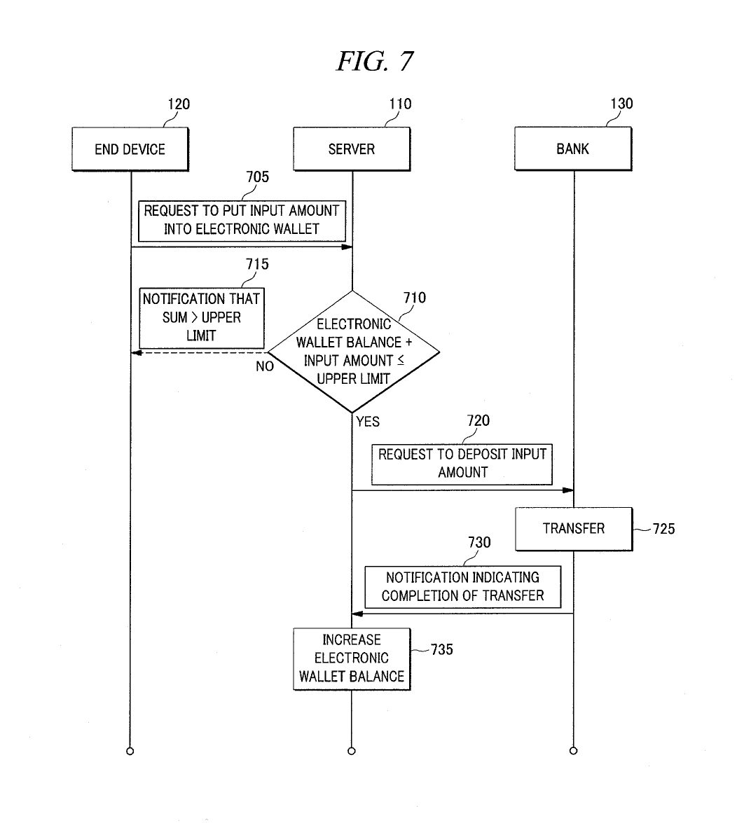

FIG. 7 shows yet another example processing flow of operations for implementing at least portions of increasing a current balance corresponding to electronic wallet 122. The process in FIG. 7 may be implemented in system configuration 100 including server 110, end device 120 and bank server 130, as described with reference to FIG. 1. An example process may include one or more operations, actions, or functions as illustrated by one or more blocks 705, 710, 715, 720, 725, 730 and/or 735. Although illustrated as discrete blocks, various blocks may be divided into additional blocks, combined into fewer blocks, or eliminated, depending on the desired implementation. Processing may begin at block 705.

Block 705 (Transmit Request to Put Input Amount into Electronic wallet) may refer to end device 120 transmitting a request to put an input amount into electronic wallet 122 hosted on end device 120. As referenced herein, a user may decide an original source of the input amount, such as a credit card account, a debit card account, a virtual account, a reward point account or a bank account, and the request to put may include information regarding the decided original source. By way of example, when the credit card account is decided as the original source, the request to put may include a credit card number, a valid date, a credit card password, etc. The information regarding the decided original source may be received from the user through a user input. Processing may proceed from block 705 to block 710.

Block 710 (Determine whether Sum of Current Balance corresponding to Electronic wallet and Input Amount Exceeds Upper Limit) may refer to server 110 determining whether a sum of a current balance corresponding to electronic wallet 122 independently managed by server 110 and the input amount exceeds an upper limit allotted to electronic wallet 122. As referenced herein, the upper limit allotted to electronic wallet 122 may be set by a user in advance. Further, the user may decide the upper limit through a user interface to set the upper limit displayed on end device 120. If the sum exceeds the upper limit, processing may proceed from block 710 to block 715, while if the sum does not exceed the upper limit, processing may proceed from block 710 to block 720.

Block 715 (Transmit Notification that Sum Exceeds Upper Limit) may refer to server 110 transmitting a notification that the sum exceeds the upper limit to end device 120 as a message indicating failure of the putting the input amount. Then, end device 120 may display the notification that the sum exceeds the upper limit. Processing may proceed from block 715 to block 720.

Block 720 (Transmit Request to Deposit Input Amount) may refer to server 110 transmitting a request to deposit the input amount to bank server 130. As referenced herein, the request to deposit may include the information regarding the decided original source. Processing may proceed from block 720 to block 725.

Block 725 (Transfer Input Amount) may refer to bank server 130 transferring the input amount to the virtual account. For example, bank server 130 may transfer the input amount from the original source to the virtual account by using the received information regarding the original source. Processing may proceed from block 725 to block 730.

Block 730 (Transmit Notification indicating Completion of Transfer) may refer to bank server 130 transmitting a notification indicating completion of transfer of the input amount to server 110. Processing may proceed from block 730 to block 735.

Block 735 (Increase Current Balance corresponding to Electronic wallet) may refer to server 110 increasing the current balance corresponding to electronic wallet 122 by the input amount. As a result, the current balance corresponding to electronic wallet 122 may equal a current balance of the virtual account independently managed by bank server 130. In some embodiments, server 110 may receive the current balance of the virtual account, and then, adjust the current balance corresponding to electronic wallet 122 to equal the current balance of the virtual account. That is, the current balance corresponding to electronic wallet 122 needs to be the same as the current balance of the virtual account. Therefore, the current balance corresponding to electronic wallet 122 may be synchronized with the current balance of the virtual account.

Thus, FIG. 7 shows yet another example processing flow of operations for implementing at least portions of increasing a current balance corresponding to electronic wallet 122.

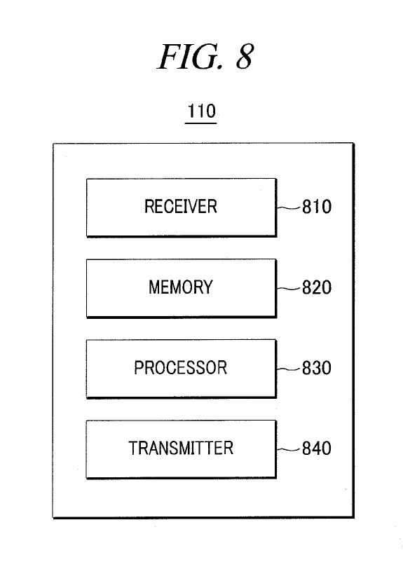

FIG. 8 shows an example configuration of a server 110 by which at least portions of electronic wallet based payment may be implemented. As depicted in FIG. 8, server 110, which is described above with regard to FIGS. 1-7, may include a receiver 810, a memory 820, a processor 830 and a transmitter 840. Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of receiver 810, memory 820, processor 830 and transmitter 840 may be included in an instance of an application hosted by server 110.

Receiver 810 may be configured to receive, from an end device 120, a request to issue electronic wallet 122 to be hosted on end device 120. As referenced herein, the request to issue electronic wallet 122 may include an identifier, such as an end device identifier and a user identifier, and a transaction password.

Receiver 810 may be further configured to receive a transaction request from end device 120. Here, the transaction request may include a payment amount to be paid, a store identifier and a test transaction password that is to be compared with the transaction password to making a payment.

Receiver 810 may be further configured to receive a notification that the virtual account has been generated with an account identifier of the generated virtual account from bank sever 130. Receiver 810 may be further configured to receive a notification indicating completion of transfer of the payment amount.

Memory 820 may be configured to store, at least, the received transaction password and the received identifier with respect to issued electronic wallet 122. Further, memory 820 may be configured to store the received account identifier of the generated virtual account with respect to issued electronic wallet 122. Memory 820 may be configured to pre-register store information corresponding to the store identifier, such as a store name, a store address, an account identifier of a store account, etc.

Processor 830 may be configured to issue electronic wallet 122 in response to the received request to issue electronic wallet 122. Processor 830 may be further configured to match the received account identifier of the virtual account to issued electronic wallet 122.

Processor 830 may be configured to compare the test transaction password included in the received transaction request with the transaction password in response to the received transaction request. Processor 830 may be further configured to retrieve the account identifier of the store account by using the store identifier included in the transaction request if the test transaction password is identical to the stored transaction password. In some embodiments, processor 830 may be configured to determine whether electronic wallet 122 or the store account is available in response to the received transaction request.

Processor 830 may be further configured to decrease a current balance corresponding to electronic wallet 122 independently managed by server 110 by the payment amount based on the received notification indicating completion to equal a current balance of the virtual account independently managed by bank server 130.

Transmitter 840 may be configured to transmit, to a bank server 130, a request to generate the virtual account corresponding to electronic wallet 122 if electronic wallet 122 is issued.

Transmitter 840 may be further configured to transmit, to bank server 130, a request to transfer the payment amount from the virtual account to the store account corresponding to the received store identifier. As referenced herein, the request to transfer may include the payment amount, the account identifier of the virtual account and the account identifier of the store account. In case that electronic wallet 122 or the store account is not available, transmitter 840 may be configured to transmit a notification that electronic wallet 122 or the store account is available.

Thus, FIG. 8 shows an example configuration of a server 110 by which at least portions of electronic wallet based payment may be implemented.

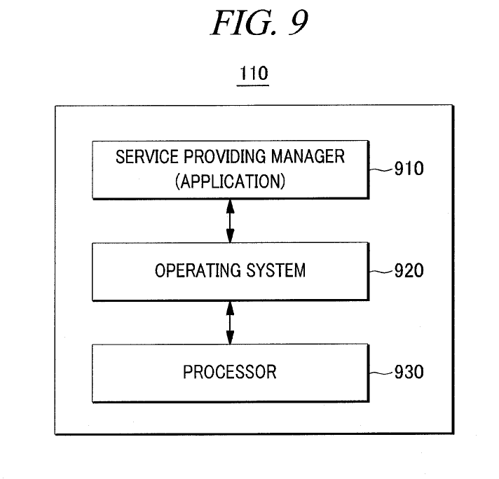

FIG. 9 shows still another example configuration of a server 110 by which at least portions of electronic wallet based payment may be implemented. As depicted in FIG. 9, server 110, which is described above with regard to FIGS. 1-8, may include a service providing manager 910, an operating system 920 and a processor 930.

Service providing manager 910 may be an application configured to operate on operating system 920 such that the electronic wallet based payment schemes as described herein may be implemented.

Operating system 920 may allow service providing manager 910 to manipulate processor 930 to implement the electronic wallet based payment schemes as described herein.

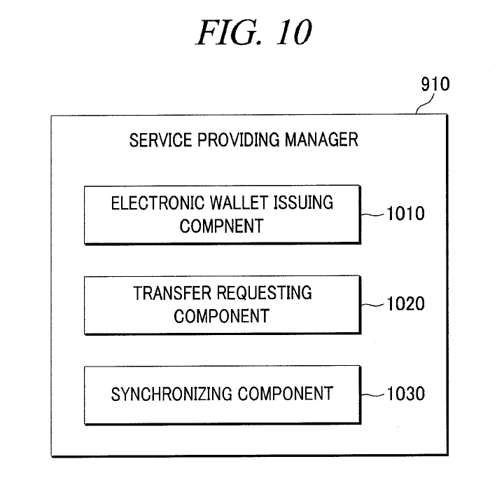

FIG. 10 shows an example configuration of a service providing manager 910 by which at least portions of electronic wallet based payment may be implemented. As depicted, service providing manager 910 may include an electronic wallet issuing component 1010, a transfer requesting component 1020 and a synchronizing component 1030.

Electronic wallet issuing component 1010 may be configured to issue electronic wallet 122 to be hosted on an end device 120 in response to a request to issue electronic wallet 122. As referenced herein, “electronic wallet 122” may refer to an application that may be hosted and executed on end device 120. Then, electronic wallet issuing component 1010 may be further configured to match an account identifier of a virtual account to issued electronic wallet 122. As referenced herein, the virtual account may be generated by bank server 130, and the account identifier of the generated virtual account may be transmitted from bank server 130 to a server 110.

Transfer requesting component 1020 may be configured to generate a request to transfer payment amount corresponding to merchandise price or service price to be paid from the virtual account to a store account. As referenced herein, the generated request may include the payment amount, the account identifier of the virtual account and an account identifier of the store account.

Synchronizing component 1030 may be configured to adjust a current balance corresponding to electronic wallet 122 independently managed by server 110 to equal a current balance of the virtual account independently managed by bank server 130. That is, the current balance corresponding to electronic wallet 122 needs to be the same as the current balance of the virtual account. Therefore, the current balance corresponding to electronic wallet 122 may be synchronized with the current balance of the virtual account

Thus, FIG. 9 shows still another example configuration of a server 110 by which at least portions of electronic wallet based payment may be implemented, and FIG. 10 shows an example configuration of a service providing manager 910 by which at least portions of electronic wallet based payment may be implemented.

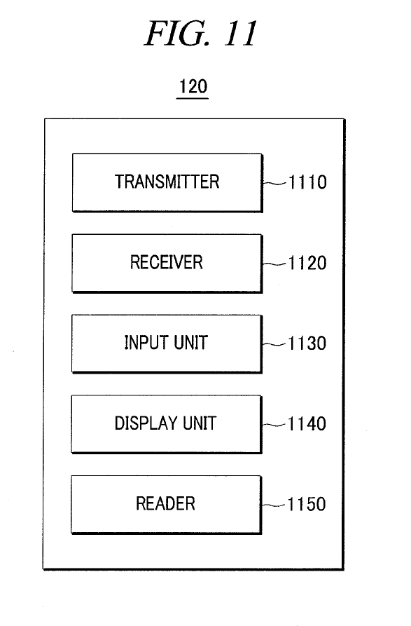

FIG. 11 shows an example configuration of an end device 120 by which at least portions of electronic wallet based payment may be implemented. As depicted in FIG. 11, end device 120, which is described above with regard to FIGS. 1-7, may include a transmitter 1110, a receiver 1120, an input unit 1130, a display unit 1140 and a reader 1150. Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of transmitter 1110, receiver 1120, input unit 1130, display unit 1140 and reader 1150 may be included in an instance of an application hosted by end device 120.

Transmitter 1110 may be configured to transmit a request to issue electronic wallet 122 and to generate a virtual account to a server 110. Transmitter 1110 may be further configured to transmit transaction request including a payment amount and a store identifier to server 110.

Receiver 1120 may be configured to receive, from server 110, a notification that electronic wallet 122 has been issued and a notification that the virtual account has been generated. Receiver 1120 may be further configured to receive, from server 110, a notification completion of transfer.

Input unit 1130 may be configured to receive a user input of an identifier and a transaction password to be included the request to issue electronic wallet 122 and to generate a virtual account. Input unit 1130 may be further configured to receive a user input of the payment amount and the store identifier to be included the transaction request. As referenced herein, input unit 1130 may receive certain user input through a user interface, such as, a touch screen, a keyboard, a mouse, etc.

Display unit 1140 may be configured to display at least one of the notification that electronic wallet 122 has been issued or the notification that the virtual account has been generated. Display unit 1140 may be further configured to display a current balance corresponding to electronic wallet 122 on a display panel.

Reader 1150 may configured to read a store identifier from an electronic tag 140 located within a predetermined communication range of end device 120. As referenced herein, electronic tag 140 may be attached to a surface of an object, such as a checkout counter, a point of sale (POS) terminal, or inserted in the object as an electronic chip. By way of example, but not limitation, reader 1150 may include a radio frequency identification reader, a near field communication reader, a barcode reader, a quick response code reader, etc.

Thus, FIG. 11 shows an example configuration of an end device 120 by which at least portions of electronic wallet based payment may be implemented.

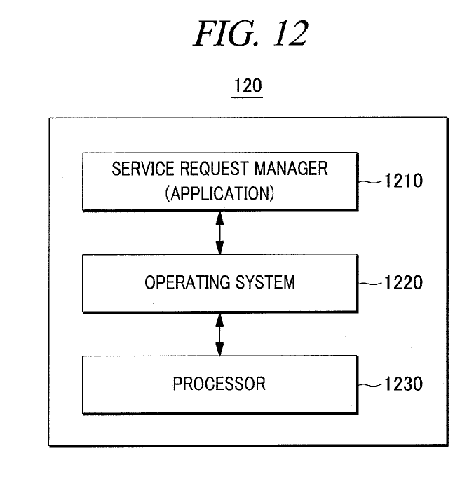

FIG. 12 shows still another example configuration of a server 110 by which at least portions of electronic wallet based payment may be implemented. As depicted in FIG. 12, end device 120, which is described above with regard to FIGS. 1-8, may include a service request manager 1210, an operating system 1220 and a processor 1230.

Service request manager 1210 may be an application adapted to operate on operating system 1220 such that the electronic wallet based payment schemes as described herein may be provided.

Operating system 1220 may allow service request manager 1210 to manipulate processor 1230 to implement the electronic wallet based payment schemes as described herein.

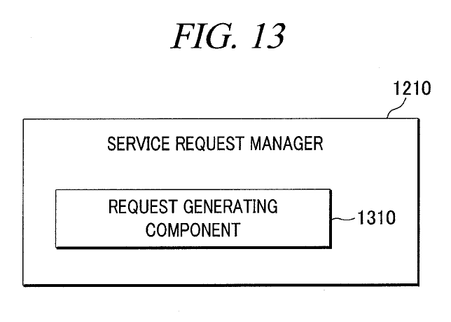

FIG. 13 shows an example configuration of a service request manager 1210 by which at least portions of electronic wallet based payment may be implemented. As depicted, service request manager 1210 may include a request generating component 1310.

Request generating component 1310 may be configured to generate at least one of a request to issue electronic wallet 122 and to generate a virtual account corresponding to electronic wallet 122, or a transaction request to transfer a payment amount from the virtual account to a store account. For example, request generating component 1310 may generate the request to issue electronic wallet 122 and to generate the virtual account by using an identifier and a transaction password those are input by a user. Further, request generating component 1310 may generate the transaction request by using the payment amount and a store identifier. As referenced herein, the payment amount may be input by the user or a casher and the store identifier may be input by a reader that reads the store identifier from an electronic tag 140. In some embodiments, the store identifier may be also input by the user or the casher.

Thus, FIG. 12 shows still another example configuration of a server 110 by which at least portions of electronic wallet based payment may be implemented, and FIG. 13 shows an example configuration of a service request manager 1210 by which at least portions of electronic wallet based payment may be implemented.

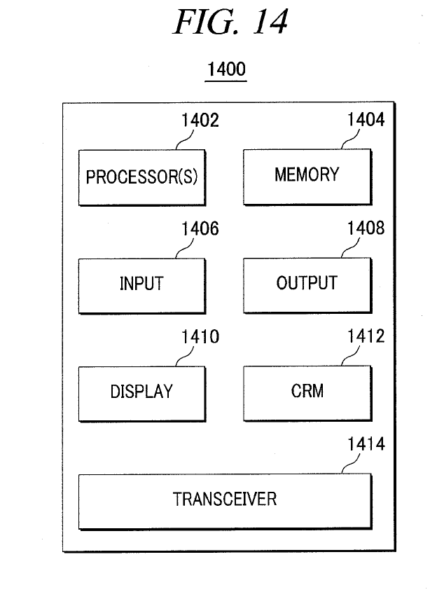

FIG. 14 shows an illustrative computing embodiment, in which any of the processes and sub-processes of electronic wallet based payment may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 1400 may typically include, at least, one or more processors 1402, a system memory 1404, one or more input components 1406, one or more output components 1408, a display component 1410, a computer-readable medium 1412, and a transceiver 1414.

Processor 1402 may refer to, e.g., a microprocessor, a microcontroller, a digital signal processor, or any combination thereof.

Memory 1404 may refer to, e.g., a volatile memory, non-volatile memory, or any combination thereof. Memory 1404 may store, therein, an operating system, an application, and/or program data. That is, memory 1404 may store executable instructions to implement any of the functions or operations described above and, therefore, memory 1404 may be regarded as a computer-readable medium.

Input component 1406 may refer to a built-in or communicatively coupled keyboard, touch screen, or telecommunication device. Alternatively, input component 1406 may include a microphone that is configured, in cooperation with a voice-recognition program that may be stored in memory 1404, to receive voice commands from a user of computing device 1400. Further, input component 1406, if not built-in to computing device 1400, may be communicatively coupled thereto via short-range communication protocols including, but not limitation, radio frequency or Bluetooth.

Output component 1408 may refer to a component or module, built-in or removable from computing device 1400, that is configured to output commands and data to an external device.

Display component 1410 may refer to, e.g., a solid state display that may have touch input capabilities. That is, display component 1410 may include capabilities that may be shared with or replace those of input component 1406.

Computer-readable medium 1412 may refer to a separable machine readable medium that is configured to store one or more programs that embody any of the functions or operations described above. That is, computer-readable medium 1412, which may be received into or otherwise connected to a drive component of computing device 1400, may store executable instructions to implement any of the functions or operations described above. These instructions may be complimentary or otherwise independent of those stored by memory 1404.

Transceiver 1414 may refer to a network communication link for computing device 1400, configured as a wired network or direct-wired connection. Alternatively, transceiver 1414 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method performed by a server, comprising:
issuing an electronic wallet to be hosted on an end device;
transmitting, to a bank, a request to generate a virtual account corresponding to the issued electronic wallet;
receiving, from the end device, a transaction request including a payment amount and a store identifier; and
transmitting, to the bank, a request to transfer the payment amount from the virtual account to a store account corresponding to the store identifier.

2. The method of claim 1, further comprising:
receiving, from the end device, another identifier and a transaction password;
registering the identifier and the transaction password associated with the electronic wallet in a memory.

3. The method of claim 2, wherein the another identifier include at least one of a user identifier or an end device identifier.

4. The method of claim 2, wherein the transaction request further includes a test transaction password, and
wherein the request to pay is transmitted to the bank when the test transaction password included in the transaction request is identical to the transaction password registered in the memory.

5. The method of claim 1, further comprising:
determining whether the payment amount is the same or less than a current balance corresponding to the electronic wallet,
wherein the transmitting the request to pay occurs when the payment amount is the same or less than the current balance corresponding to the electronic wallet.

6. The method of claim 5, further comprising:
transmitting, to the end device, an alert message if the payment amount is greater than the current balance corresponding to the electronic wallet.

7. The method of claim 1, further comprising:
receiving, from the bank, a request to deposit a deposit amount to the virtual account corresponding to the electronic wallet; and
determining whether a sum of a current balance corresponding to the electronic wallet and the deposit amount exceeds an upper limit allotted to the electronic wallet.

8. The method of claim 7, further comprising:
transmitting, to the bank, a notification that the sum exceeds the upper limit allotted to the electronic wallet.

9. The method of claim 7, further comprising:
transmitting, to the bank, a notification that the sum is same or less than the upper limit allotted to the electronic wallet; and
increasing the current balance corresponding to the electronic wallet by the deposit amount.

10. The method of claim 1, further comprising:
receiving, from the end device, a request to put an input amount into the electronic wallet; and
determining whether a sum of a current balance corresponding to the electronic wallet and the input amount exceeds an upper limit allotted to the electronic wallet.

11. The method of claim 10, further comprising:
transmitting, to the end device, a notification that the sum exceeds the upper limit allotted to the electronic wallet.

12. The method of claim 10, further comprising:
transmitting, to the bank, a request to deposit the input amount to the virtual account corresponding to the electronic wallet; and
increasing the current balance corresponding to the electronic wallet by the input amount.

13. The method of claim 1, wherein an account identifier of the store account is retrieved from a memory by using the store identifier.

14. The method of claim 1, further comprising:
retrieving store information corresponding to the store identifier from a memory; and
transmitting, to the end device, the retrieved store information including a store name and a store address.

15. A method performed by an end device, comprising:
transmitting, to a server, a request to issue an electronic wallet and to generate a virtual account;
receiving, from the server, a notification that the electronic wallet has been issued and a notification that the virtual account has been generated;
receiving input data including a payment amount and a store identifier; and
transmitting, to the server, transaction information including the payment amount and the store identifier.

16. The method of claim 15, further comprising:
reading the store identifier from an electronic tag located within a predetermined communication range of the end device.

17. The method of claim 15, further comprising:
receiving, from the server, store information corresponding to the store identifier; and
displaying the received store information.

18. A server, comprising:
a processor configured to issue an electronic wallet to be hosted on an end device;
a memory configured to store a transaction password with respect to the issued electronic wallet;
a transmitter configured to transmit, to a bank, a request to generate a virtual account corresponding to the issued electronic wallet;
a receiver configured to receive, from the end device, a transaction request including a payment amount, a store identifier and a test transaction password,
wherein the processor is further configured to compare the test transaction password included in the transaction request with the transaction password stored in the memory, and
wherein the transmitter is further configured to transmit, to the bank, a request to transfer the payment amount from the virtual account to a store account corresponding to the store identifier.

19. The server of claim 18, wherein the receiver is further configured to receive, from the bank, an account identifier of the generated virtual account, and
wherein the processor is further configured to match the received account identifier of the virtual account to the issued electronic wallet.

20. The server of claim 18, wherein the receiver is further configured to receive, from the bank, a notification indicating completion of transfer of the payment amount, and
wherein the processor is further configured to decrease the current balance corresponding to the electronic wallet by the payment amount.

21. The server of claim 18, wherein the processor is further configured to determine whether the electronic wallet or the store account is available, and
wherein the transmitter is further configured to transmit, to the end device, a notification that the electronic wallet or the store account is not available.

22. An end device, comprising:
a transmitter configured to transmit, to a server, a request to issue an electronic wallet and to generate a virtual account;
a receiver configured to receive, from the server, a notification that the electronic wallet has been issued and a notification that the virtual account has been generated;
an input unit configured to receive an input of a payment amount and a store identifier,
wherein the transmitter is further configured to transmit, to the server, transaction information including the payment amount and the store identifier.

23. The end device of claim 22, further comprising:
a display unit configured to display at least one of the notification that the electronic wallet has been issued or the notification that the virtual account has been generated.

24. The end device of claim 22, wherein the display unit is further configured to display a current balance corresponding to the electronic wallet.

25. The end device of claim 22, wherein the electronic wallet corresponds to a plurality of virtual accounts.
